(19) United States
(12) Patent Application Publication
(10) Pub. No.: US 2021/0114909 A1
(43) Pub. Date: Apr. 22, 2021

(54) DRINKING STRONTIUM-RICH MINERAL WATER PREPARED FROM SALT-MAKING DISTILLED WATER, AND METHOD AND SYSTEM THEREOF

(71) Applicants: Xuebing ZHAO, Beijing (CN); Dehua LIU, Beijing (CN); Ziyuan ZHOU, Beijing (CN); Lingmei DAI, Beijing (CN); Chenghua ZOU, Zigong (CN)

(72) Inventors: Xuebing ZHAO, Beijing (CN); Dehua LIU, Beijing (CN); Ziyuan ZHOU, Beijing (CN); Lingmei DAI, Beijing (CN); Chenghua ZOU, Zigong (CN)

(21) Appl. No.: 17/076,832

(22) Filed: Oct. 22, 2020

(30) Foreign Application Priority Data
Oct. 22, 2019 (CN) 201911004541.0

(51) Int. Cl. C02F 9/00; B01D 39/06

(52) U.S. Cl. CPC C02F 9/00; C02F 1/78; C02F 2303/04; B01D 39/06

(57) ABSTRACT

The invention provides a method for preparing strontium-rich mineral water from distilled water obtained in the salt production process from brine, which comprises the following steps: carrying out aeration pretreatment on the salt-making distilled water to obtain pretreated distilled water, and further performing sand filtration, ion exchange, activated carbon, membrane filtration and sterilization and disinfection treatment on the pretreated distilled water to obtain the drinking strontium-rich mineral water with the strontium element content of more than 0.4 mg/L. The method provided by the invention prepares distilled water obtained in a brine evaporation salt making process into drinkable strontium-rich mineral water, which not only realizes comprehensive utilization of resources, but also realizes retention and enrichment of strontium element in the distilled water and effective adjustment of strontium element content, obtaining a high-end product of the strontium-rich mineral water and obviously improving economy of the process.

### BACKGROUND OF THE INVENTION

### 1. Field of the Invention

The invention relates to the field of food, specifically relating to a drinking strontium-rich mineral water prepared by taking distilled water which is a byproduct obtained in the process of preparing salt from brine via evaporation method as a raw material, and preparation method and system thereof.

### 2. Description of the Related Art

Common salt, also called table salt, is one of the most important substances for human survival as well as the most commonly used seasoning in cooking. The main component of common salt is sodium chloride. The common salt can be divided into crude salt and refined salt. The crude salt is prepared from seawater, mineral salt water solution, souse of salt well, and salt water of salt pond by decocting, drying in the sun, filtering, concentrating, and crystallizing. Refined salt is produced by recrystallizing the crude salt and chemically removing impurities such as sulfates and sodium carbonate in alkali metal and alkaline earth metal. Both crude and refined salt preparations involve evaporation and concentration, i.e., the bittern solution is evaporated to remove water to concentrate the bittern. In the process of preparing common salt from well and mine bittern, 2-3 tons of water are evaporated when 1 ton of common salt is produced, and most of distilled water is directly discharged except that part of distilled water returns to underground to dissolve salt mine, bringing about resource waste.

Bittern contains various kinds of elements, and a small amount of elements such as sodium, calcium, strontium and the like are inevitably introduced into distilled water during evaporation. Among them, strontium is an element beneficial to the human body. Strontium, one of essential trace elements in human body, is closely related to the formation of human skeleton and is the main component of skeleton and teeth. Strontium exists in all tissues of human body and has competitive adsorption sites with sodium in intestines, which can decrease adsorption of sodium in human body and facilitate normal cardiovascular activities. Strontium can be used for treating convulsion due to parathyroid insufficiency, and strontium deficiency can incur dental caries. The strontium amount in food is related with the strontium amount in local water quality and soil, and generally, intake of 2 mg strontium each day can meet an adult's physiological needs (Wu Maojiang. Strontium and Human Health. Studies of Trace Elements and Health, 2012, 29(5): 66-67). The mineral water with the strontium content of less than 5 mg/L is beneficial to human health and does not produce adverse effects. Strontium is determined as one of the necessary components in Standards for Chinese Drinking Mineral Water GB8537-2018, and is determined as a limit index and a limited amount index, in which the content of strontium in mineral water is regulated to be more than or equal to 0.2 mg/L. Studies have shown that strontium levels in drinking water and urine are significantly negatively correlated with hypertensive heart disease; the ratio of the sodium to the strontium in the drinking water is in positive correlation with the vascular injury of the central nervous system, arteriosclerosis, degenerative heart disease and hypertensive heart disease; the sodium/strontium ratio of urine is significantly negatively correlated with systemic arteriosclerosis (Liang Ziyu, Yang Ping, Li Zhongcheng. Studies on the Relationship of Strontium to Cardiovascular Disease. People's Military Surgeon, 2007, 50(12): 768-769). Excessive sodium in vivo constitutes the main reason for hypertension and cardiovascular diseases, and strontium is related to the function and structure of blood vessels the action mechanism of which may be that strontium has competitive adsorption sites with sodium in intestines so as to reduce body's adsorption for sodium and increase the discharge amount of sodium out of the body along with urine, accordingly lowering the sodium content in the body; Strontium is also related to the function and structure of the blood vessels, therefore the strontium can effectively prevent hypertension and cardiovascular diseases (Wu Maoiiang. Strontium and Human Health. Studies of Trace Elements and Health, 2012, 29(5): 66-67). Therefore, if the distilled water for salt manufacturing is prepared into the strontium-rich drinking mineral water, it can not only fully utilize the resources, but also bring about huge additional benefits to salt-manufacturing enterprises. However, the key problems of getting rid of peculiar smell, controlling sodium content, and improving strontium content and the like need to be solved in the preparation of the drinking strontium-rich mineral water from the salt brine.

### SUMMARY OF THE INVENTION

The invention aims to solve at least one of the technical problems in the related technology to a certain extent which prepares drinking strontium-rich mineral water from distilled water obtained in the salt making process, significantly enhancing economic benefit of the process at the time of realizing comprehensive utilization of resources.

The invention is provided based on the following findings of the inventors: the brine is evaporated and concentrated to obtain salt and distilled water. The brine contains a large amount of sodium chloride as well as some trace elements, such as strontium. Sodium ions, strontium ions, calcium ions and the other ions are inevitably brought into the distilled water during the evaporation process, but the content of these ions is much lower compare with that of brine, wherein the content of the sodium ions is usually more than 40 ppm, the content of the calcium ions below 10 ppm, and the content of strontium elements usually below 0.4 ppm. The distilled water can be used as raw water for preparing drinking mineral water. However, trace amounts of sulfides such as hydrogen sulfide may exists in distilled water which must be removed to meet drinking water standards. In addition, too high sodium ion content will affect the drinking water taste and the strontium ion content should be increased to meet the strontium-rich mineral water standard. The hydrogen sulfide has reducibility and can be oxidized into solid elemental sulfur via aeration treatment so as to be removed; solid impurities in the distilled water can be removed through physical filtration, and the content of sodium ions and strontium ions can be regulated by combining ion exchange and membrane filtration treatment, and particularly, the content of the sodium ions can be controlled by combining reverse osmosis and nanofiltration membrane separation to selectively enrich the strontium ions.

To this end, it is an object of the invention to provide a drinking strontium-rich mineral water and a method and system thereof.

In one aspect of the invention, it provides a drinking strontium-rich mineral water. According to embodiments of the invention, said drinking strontium-rich mineral water contains 2-100 mg/L of sodium ions, 0.4-1.5 mg/L of strontium ions, and 0.5-20 mg/L of calcium ions. Said drinking strontium-rich mineral water has high strontium content, and can supplement necessary strontium element for human body at the time of supplementing daily water.

In some embodiments of the invention, the drinking strontium-rich mineral water contains 10-80 mg/L sodium ions and 0.4-1.0 mg/L strontium ions.

In another aspect of the invention, it provides a method for preparing drinking strontium-rich mineral water. According to embodiments of the invention, said method comprises: (1) carrying out aeration pretreatment on the salt-making distilled water to obtain pretreated distilled water; (2) performing sand filtration treatment on said pretreated distilled water to obtain first treated water; (3) conducting ion exchange treatment on said first treated water to obtain second treated water; (4) performing activated carbon adsorption treatment on said second treated water to obtain third treated water; (5) performing membrane filtration treatment on said third treated water to obtain fourth treated water; and (6) sterilizing and disinfecting the fourth treated water to obtain the drinking strontium-rich mineral water. The method, taking distilled water obtained by evaporating and concentrating salt-making brine as raw material, can effectively remove sulfide and other impurities in the salt-making distilled water, controls the content of sodium ions, and enriches strontium ions, thereby preparing the drinking strontium-rich mineral water.

In addition, the method for preparing drinking strontium-rich mineral water according to the above embodiment of the invention may further have the following additional technical features:

In some embodiments of the invention, said operating conditions of the aeration pretreatment comprise: the air ventilation amount is 0.1-10 vvm, the temperature is 20-60° C., and the retention time is 1-60 minutes.

In some embodiments of the invention, said conditions of the sand filtration process include: the temperature is 20-60° C., and the retention time is 1-30 minutes.

In some embodiments of the invention, said ion exchange treatment is cation exchange, and the treatment conditions include: the temperature is 20-50° C., and the retention time is 1-60 minutes.

In some embodiments of the invention, the conditions of the activated carbon adsorption treatment include: the temperature is 20-40° C., and the retention time is 10-60 minutes.

In some embodiments of the invention, the conditions of the membrane filtration process include: the temperature is 20-40° C., the operation pressure is 0.15-5 MPa, and the concentration ratio is 10:(9-2).

In some embodiments of the invention, the conditions of the sterilization and disinfection process include: the temperature is 20-40° C., the ozone dosage is 1-10 g/L water, and the retention time is 1-30 minutes.

In a further aspect of the invention, the invention provides a system for implementing said method for preparing drinking strontium-rich mineral water in the above embodiment. According to embodiments of the invention, said system comprises: the aeration unit, the sand filtration unit, the ion exchange unit, the activated carbon adsorption treatment unit, the membrane filtration unit and the sterilization and disinfection unit are connected in sequence. By using said system, the distilled water for preparing salt can be continuously prepared into the drinking strontium-rich mineral water.

In addition, the system for preparing drinking strontium-rich mineral water according to the above embodiment of the invention may also possess the following additional technical features:

In some embodiments of the invention, said sand filtration unit comprises a coarse sand filtration apparatus and a fine sand filtration apparatus.

In some embodiments of the invention, the activated carbon adsorption treatment unit comprises a primary activated carbon adsorption treatment device and a secondary activated carbon adsorption treatment device.

In some embodiments of the invention, the membrane filtration unit comprises a reverse osmosis apparatus and/or a nanofiltration apparatus.

In yet another aspect of the invention, it provides a drinking strontium-rich mineral water. According to the embodiment of the invention, said drinking strontium-rich mineral water is prepared by the method for preparing the drinking strontium-rich mineral water or the system for preparing the drinking strontium-rich mineral water of the above embodiment. Said drinking strontium-rich mineral water contains 2-100 mg/L sodium ions, 0.4-1.5 mg/L strontium ions and 0.5-20 mg/L calcium ions. The drinking strontium-rich mineral water possesses high strontium content, and can supplement necessary strontium element for human body at the time supplementing daily water.

Additional aspects and advantages of the invention will be set forth in part in the following description and, in part, will be obvious from the following description, or may be learned by practice of the invention.

### BRIEF DESCRIPTION OF THE DRAWINGS

The above and/or additional aspects and advantages of the invention will become apparent and readily appreciated from the following description of the embodiments, taken in combination with the accompanying drawings thereof:

FIG. 1 is a schematic flow diagram illustrating the method for preparing drinking strontium-rich mineral water according to one embodiment of the invention;

FIG. 2 is a schematic diagram illustrating the system structure for preparing drinking strontium-rich mineral water according to one embodiment of the invention.

### REFERENCE NUMERALS

100: the aeration unit; 200: the sand filtration unit; 300: the ion exchange unit; 400: the activated carbon adsorption treatment unit; 500: the membrane filtration unit; 600: the sterilization and disinfection unit.

### DETAILED DESCRIPTION OF THE PREFERRED EMBODIMENTS

Reference will now be made in detail to embodiments of the invention, examples of which are illustrated in the drawings, wherein identical or similar reference numerals refer to the same or similar elements or elements with identical or similar function throughout. The embodiments described below with reference to the drawings are illustrative and intended to be illustrative of the invention and are not to be construed as limiting the invention. The specific techniques or conditions not specified in the examples should be viewed as the techniques or conditions described in the literature of the field or according to the product description

Furthermore, the terms “first,” “second,” “third,” “fourth,” and the like are used for descriptive purposes only and are not to be construed as indicating or implying relative importance or implicit to the number of indicated technical features. Thus, features defined as “first,” “second,” “third,” “fourth,” etc. may explicitly or implicitly include at least one such feature. In the description of the invention, “a plurality” means at least two, e.g., two, three, etc., unless specifically limited otherwise.

In the invention, unless otherwise expressly specified or limited, the terms “connected” and other terms are to be construed broadly, e.g., as either fixed connection, removable connection, or an integral part; and can be mechanically or electrically connected; they may be directly connected or indirectly connected via intervening media, or they may be connected internally or in interactive relationship, unless expressly stated otherwise. The specific meanings of the above terms in the invention can be understood by those skilled in the art according to specific situations.

In one aspect of the invention, it provides a drinking strontium-rich mineral water. According to the embodiment of the invention, the drinking strontium-rich mineral water contains 2-100 mg/L of sodium ions, 0.4-1.5 mg/L of strontium ions, and 0.5-20 mg/L of calcium ions. The drinking strontium-rich mineral water has high strontium content and can supplement necessary strontium element for human body at the time of supplementing daily water.

According to the embodiment of the invention, said drinking strontium-rich mineral water contains 2-100 mg/L of sodium ions, and specifically, the concentration of the sodium ions can be 2 mg/L, 10 mg/L, 40 mg/L, 80 mg/L, 100 mg/L and the like. By controlling the concentration of sodium ions in the drinking strontium-rich mineral water within the above range, the mineral water can have a good taste. If the content of sodium ions is too high, not only the taste of the mineral water is deteriorated, but also the health of human body is adversely affected. The drinking strontium-rich mineral water contains 0.4-1.5 mg/L strontium ions, specifically, the concentration of the strontium ions can be 0.4 mg/L, 0.6 mg/L, 1.0 mg/L, 1.2 mg/L, 1.5 mg/L, etc. Therefore, the strontium content in the mineral water is high and can supplement necessary strontium element for human body at the time supplementing daily water. In addition, the concentration of calcium ion in the drinking strontium-rich mineral water is 0.5-20 mg/L, specifically 0.5 mg/L, 1 mg/L, 5 mg/L, 10 mg/L, 15 mg/L, 20 mg/L and the like.

According to a preferred embodiment of the invention, the drinking strontium-rich mineral water contains 10-80 mg/L sodium ions and 0.4-1.0 mg/L strontium ions. By controlling the concentration of sodium ions and strontium ions in the mineral water within the above range, the taste and the health care performance of the mineral water can be further improved on the premise of ensuring higher strontium content in the mineral water.

In addition, the main component of the drinking strontium-rich mineral water is water, and the concentrations of sodium ions, strontium ions and calcium ions in the invention are the concentrations thereof in water, unless otherwise specified.

In another aspect of the invention, the invention provides a method for preparing drinking strontium-rich mineral water. According to the embodiment of the invention, the method comprises: (1) carrying out aeration pretreatment on the salt-making distilled water to obtain pretreated distilled water; (2) performing sand filtration treatment on said pretreated distilled water to obtain first treated water; (3) conducting ion exchange treatment on said first treated water to obtain second treated water; (4) performing activated carbon adsorption treatment on said second treated water to obtain third treated water; (5) performing membrane filtration treatment on said third treated water to obtain fourth treated water; and (6) sterilizing and disinfecting the fourth treated water to obtain the drinking strontium-rich mineral water. The method, taking distilled water obtained by evaporating and concentrating salt-making brine as raw material, can effectively remove sulfide and other impurities in the salt-making distilled water, controls the content of sodium ions, and enriches strontium ions, thereby preparing the drinking strontium-rich mineral water.

Specifically, the salt-making brine contains a certain amount of strontium element, so that distilled water obtained by evaporating the salt-making brine (namely salt-making distilled water) also contains trace strontium element, and can be used as raw water for producing the drinking strontium-rich mineral water.

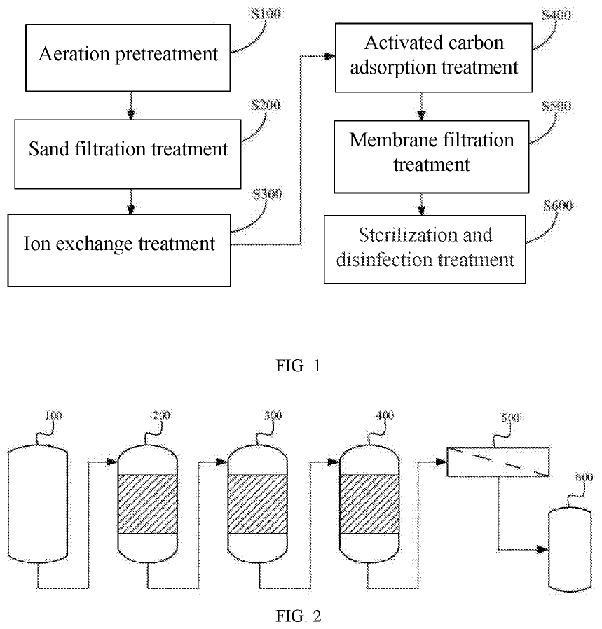

A method for preparing drinking strontium-rich mineral water according to the embodiment of the invention is further described in detail with reference to FIG. 1. According to the embodiment of the invention, the method comprises:

S100: Aeration Pretreatment

In the step, the salt-making distilled water is subjected to aeration pretreatment to obtain pretreated distilled water. A certain amount of sulfides such as hydrogen sulfide are often dissolved in well and mine brine. Despite the fact that part of sulfides in the well and mine brine can be removed by pretreatment in the salt production process, a small amount of sulfides such as hydrogen sulfide inevitably remains in the distilled water for salt production obtained by evaporation. Aeration pretreatment on the salt production distilled water can effectively getting rid of sulfides such as hydrogen sulfide and the like in the salt production distilled water. Specifically, the aeration pretreatment may be performed by introducing air into the salt manufacturing distilled water for aeration, whereby sulfides such as hydrogen sulfide with strong reducing property in the salt manufacturing distilled water can be effectively removed.

According to some embodiments of the invention, the operating conditions of the aeration pretreatment include: the air ventilation amount is 0.1-10 vvm, the temperature is 20-60° C., and the retention time is 1-60 minutes. Specifically, the air ventilation amount may be 0.1 vvm, 1 vvm, 3 vvm, 6 vvm, 10 vvm, etc., the temperature may be 20° C., 30° C., 40° C., 50° C., 60° C., etc., and the retention time (i.e., the time for the aeration pretreatment of the salt manufacturing distilled water) may be 1 minute, 5 minutes, 15 minutes, 30 minutes, 45 minutes, 60 minutes, etc. By carrying out aeration pretreatment under said conditions, most of residual hydrogen sulfide in the distilled water for salt production can be removed, so that the sulfide content of the product meets the drinking water standard.

S200: Sand Filtration Treatment

In the step, the pretreated distilled water is subjected to sand filtration treatment to obtain first treated water. Distilled water obtained by evaporation of salt making equipment may contain solid impurities such as iron filings and the like, and pretreated distilled water subjected to aeration pretreatment may also contain a small amount of sulfur solids. The solid impurities can be effectively removed by subjecting the pretreated distilled water to sand filtration. Preferably, the sand filtration process sequentially uses coarse sand filters and fine sand filters to remove solid impurities step by step, which means that the coarse sand filters removes larger particles and the fine sand filters removes fine particles.

According to some embodiments of the invention, the conditions of the sand filtration process include: the temperature is 20-60° C., and the retention time is 1-30 minutes. Specifically, the temperature may be 20° C., 30° C., 40° C., 50° C., 60° C. or the like, and the retention time (i.e., the time during which the pretreated distilled water is retained in the sand filtration unit) may be 1 minute, 5 minutes, 15 minutes, 30 minutes or the like. Therefore, the solid particles in the pretreatment water can be completely removed without causing obvious pressure drop and blockage of the treatment unit.

S300: Ion Exchange Treatment

In the step, the first treated water is subjected to ion exchange treatment to obtain second treated water. Through the ion exchange treatment, the contents of sodium ions and calcium ions in the water can be effectively controlled. In some embodiments, the second treated water obtained by the ion exchange treatment has a sodium ion content of 2-100 mg/L (preferably 10 to 80 mg/L) and a calcium ion content of 0.5-20 mg/L. Excessively high content of sodium ions will adversely affect the taste of the prepared drinking mineral water and excessively high content of calcium ions will lead to high hardness of the drinking mineral water.

According to some embodiments of the invention, the ion exchange treatment is cation exchange treatment (i.e. performed via cation exchange resin), and the treatment conditions include: the temperature is 20-50° C., and the retention time is 1-60 minutes. Specifically, the temperature may be 20° C., 30° C., 40° C., 50° C. or the like, and the retention time (i.e., the time during which the first treated water is retained in the ion exchange unit) may be 1 minute, 5 minutes, 15 minutes, 30 minutes, 45 minutes, 60 minutes or the like. Therefore, the content of sodium ions and calcium ions in the water can be controlled within a proper range.

S400: Activated Carbon Adsorption Treatment

In the step, the second treated water is subjected to activated carbon adsorption treatment to obtain third treated water through which impurities such as peculiar smell and pigment which may exist in the second treated water can be effectively removed. Preferably, the activated carbon adsorption treatment is a two-stage treatment, i.e., granular activated carbon adsorption treatment and powdered activated carbon adsorption treatment. The granular activated carbon adsorption treatment is used as coarse adsorption, and can remove most of impurities such as peculiar smell and pigment in water. The powdered activated carbon adsorption treatment is used for fine adsorption to remove impurities such as residual peculiar smell and pigment. The two-stage activated carbon adsorption treatment can effectively avoid defects of too large pressure drop and small water flux existing in the single use of powdered activated carbon adsorption and that of incomplete removal of impurities such as peculiar smell and pigments existing in the single use of granular activated carbon adsorption.

According to some embodiments of the invention, the conditions of the above activated carbon adsorption treatment include: the temperature is 20-40° C., and the retention time is 10-60 minutes. Specifically, the temperature may be 20° C., 30° C., 40° C. or the like, and the retention time (i.e., the time during which the second treated water is retained in the activated carbon adsorption treatment unit) may be 1 minute, 5 minutes, 15 minutes, 30 minutes, 45 minutes, 60 minutes or the like. Thus, impurities such as peculiar smell and pigment in the water can be completely removed.

S500: Membrane Filtration Treatment

In the step, the third treated water is subjected to membrane filtration treatment to obtain fourth treated water. Therefore, strontium ions in the third treated water can be effectively enriched to obtain product with high strontium content. Specifically, the membrane filtration treatment includes reverse osmosis membrane filtration treatment and/or nano membrane filtration treatment. Preferably, the third treated water is subjected to reverse osmosis membrane filtration treatment and nano membrane filtration treatment in sequence.

According to some embodiments of the invention, the conditions of said membrane filtration process include: the temperature is 20-40° C., the operation pressure is 0.15-5 MPa, and the concentration ratio is 10:(9-2). Specifically, the temperature may be 20° C., 30° C., 40° C. or the like, the operating pressure may be 0.15 MPa, 0.5 MPa, 1 MPa, 3 MPa, 5 MPa or the like, and the concentration ratio may be 10:9, 10:6, 10:9, 10:5, 10:4, 10:3, 10:2 or the like. Wherein the concentration ratio is defined as the ratio of the original volume of water to be treated entering the membrane filtration to the volume of the residual water. Under the operating condition, the strontium ion content in the water to be treated can be enriched from less than 0.3 mg/L to more than 0.4 mg/L. However, reverse osmosis membrane filtration is almost not selective for monovalent ions (e.g., sodium ions) and divalent ions (e.g., strontium ions and calcium ions), and sodium ions are enriched along with enrichment of strontium ions. When the sodium ion content in the raw water is low, and when the sodium ion content is controlled within the standard range, the membrane filtration process can be realized through one-step reverse osmosis membrane filtration. Preferably, according to the embodiment of the invention, the reverse osmosis membrane filtration is followed by nano membrane filtration, and the strontium ion content is increased through the selective ion separation of the nanofiltration, while the sodium ion concentration is kept constant or reduced. According to the embodiment of the invention, the preferable operating conditions of the nano membrane filtration are that the temperature is 20-40° C., the operating pressure is 0.15-5 MPa, and the concentration ratio is 10:(9-3) under which the strontium ion content can be enriched to 0.4-1.5 mg/L, preferably 0.4-1.0 mg/L, and the sodium ion content is controlled to 2-100 mg/L, preferably 10-80 mg/L. Therefore, by combining reverse osmosis and nanofiltration membrane filtration, both the enrichment of strontium ions and the regulation and control of the content of the strontium ions can be realized.

S600: Sterilization and Disinfection Treatment

In the step, the fourth treated water is sterilized and disinfected to obtain the drinking strontium-rich mineral water. Specifically, the sterilization and disinfection treatment may be performed by sterilization and disinfection method such as ultraviolet rays, ozone, hypochlorous acid, or the like.

According to some embodiments of the invention, the sterilization and disinfection process conditions include: the temperature is 20-40° C., the ozone dosage is 1-10 g/L water, and the retention time is 1-30 minutes. Specifically, the temperature may be 20° C., 30° C., 40° C. or the like, the ozone dosage may be 1 g/L, 3 g/L, 5 g/L, 8 g/L, 10 g/L or the like, and the retention time (time for performing the sterilization and disinfection treatment) may be 1 minute, 5 minutes, 15 minutes, 30 minutes or the like. Therefore, indexes such as microbial colony number in the obtained product can meet the national standard.

In a further aspect of the invention, the invention provides a system for implementing the method for preparing drinking strontium-rich mineral water of the above embodiment. According to embodiments of the invention, with reference to FIG. 2, the system comprises the aeration unit 100, the sand filtration unit 200, the ion exchange unit 300, the activated carbon adsorption treatment unit 400, the membrane filtration unit 500 and the sterilization and disinfection unit 600 connected in sequence. By using said system, the distilled water for preparing salt can be continuously prepared into the drinking strontium-rich mineral water.

According to some embodiments of the invention, the aeration unit 100 is adapted to carry out aeration pretreatment on the salt-making distilled water to obtain pretreated distilled water. The specific type of said aeration unit 100 is not particularly limited, and for example, the aeration tank commonly used in the art may be used.

According to some embodiments of the invention, the sand filtration unit 200 is adapted to perform sand filtration treatment on said pretreated distilled water to obtain first treated water. The specific type of said sand filtration unit 200 is not particularly limited, and for example, the sand filtration column commonly used in the art may be used. Preferably, the sand filtration unit 200 includes coarse sand filtration apparatus and fine sand filtration apparatus. Specifically, the coarse sand filtration apparatus may be a coarse sand filtration column common in the art, and the fine sand filtration apparatus may be a fine sand filtration column common in the art, and the filler particle size in the coarse sand filtration apparatus is larger than that in the fine sand filtration apparatus. Accordingly, sand filtration unit 200 adopts coarse sand filters and fine sand filters to get rid of solid impurity step by step in sequence which means that the coarse sand filters removes larger particles and the fine sand filters removes fine particles.

According to some embodiments of the invention, the ion exchange unit 300 is adapted to conduct ion exchange treatment on said first treated water to obtain second treated water. The specific type of the ion exchange unit 300 is not particularly limited, and for example, the ion exchange column commonly used in the art, preferably the cation exchange resin exchange column, may be used.

According to some embodiments of the invention, the activated carbon adsorption treatment unit 400 is adapted to performing activated carbon adsorption treatment on said second treated water to obtain third treated water. The specific type of said activated carbon adsorption treatment unit 400 is not particularly limited, and for example, the activated carbon adsorption column commonly used in the art may be used. Preferably, the activated carbon adsorption treatment unit 400 includes a primary activated carbon adsorption treatment device and a secondary activated carbon adsorption treatment device. Granular activated carbon is filled in the primary activated carbon adsorption treatment apparatus, and powdered activated carbon is filled in the secondary activated carbon adsorption treatment apparatus. The two-stage activated carbon adsorption treatment can effectively avoid defects of too large pressure drop and small water flux existing in the single use of powdered activated carbon adsorption and that of incomplete removal of impurities such as peculiar smell and pigments existing in the single use of granular activated carbon adsorption.

According to some embodiments of the invention, the membrane filtration unit 500 is adapted to perform membrane filtration on the third treated water to obtain fourth treated water. Said membrane filtration unit 500 includes a reverse osmosis apparatus and/or a nanofiltration apparatus. Therefore, both the enrichment of strontium ions and the regulation and control of the content of the strontium ions can be realized.

According to some embodiments of the invention, the sterilization and disinfection unit 600 is adapted to sterilize the fourth treated water to obtain drinking strontium-rich mineral water. The specific type of the sterilization and disinfection unit 600 is not particularly limited, and the sterilization and disinfection tank commonly used in the art may be used, for example.

In yet another aspect of the invention, it provides a drinking strontium-rich mineral water. According to the embodiment of the invention, the drinking strontium-rich mineral water is prepared by the method for preparing the drinking strontium-rich mineral water or the system for preparing the drinking strontium-rich mineral water of the above embodiment. Said strontium-rich drinking mineral water contains 2-100 mg/L sodium ions (preferably 10-80 mg/L), 0.4-1.5 mg/L strontium ions (preferably 0.4-1.0 mg/L) and 0.5-20 mg/L calcium ions. The drinking strontium-rich mineral water has high strontium content and can supplement necessary strontium element for human body at the time of supplementing daily water.

The invention will now be described with reference to specific embodiments, which are intended to be illustrative only and not to be limiting in any way.

### Embodiment 1: Ion Content Analysis of Distilled Water for Salt Production

The distilled water for salt production is obtained from an industrialized five-effect evaporation salt production system of SICHUAN ZIGONG CHI YU SALT PRODUCT CO., LTD. The ICP analysis showed the main ion content of each effect condensate water as shown in Table 1. The ion contents of different effects are different, but gradually increase from the first effect to the fifth effect wherein the content of sodium ions is 0.6-60 ppm, the content of calcium ions is 2-13 ppm, and the content of strontium ions is 0.02-1 ppm. Therefore, the salt-making distilled water can be used as raw water for preparing drinking mineral water, but the ion enrichment or regulation is required to meet the standard requirements based on their different resources.

TABLE 1
Main ion content of distilled water for salt
production by five-effect evaporation

| | First | Second | Third | Fourth | Fifth |
|---|---|---|---|---|---|
| | effect | effect | effect | effect | effect |
| PH | 7.80 | 8.93 | 8.81 | 8.98 | 9.18 |
| Conductivity/ | 22.00 | 121 | 239 | 585 | 498 |
| (μs/cm) | | | | | |
| Na⁺/ppm | 0.62 | 9.74 | 11.93 | 54.49 | 53.13 |
| Mg²⁺/ppm | 0.35 | 0.47 | 0.90 | 9.04 | 6.21 |
| Ca²⁺/ppm | 2.88 | 3.10 | 4.06 | 18.93 | 12.77 |
| Sr²⁺/ppm | 0.02 | 0.10 | 0.18 | 0.91 | 0.62 |
| Se/ppm | 0.00 | 0.01 | 0.01 | 0.00 | 0.00 |
| Cl⁻/ppm | 2.44 | 16.19 | 21.59 | 140 | 124 |

### Embodiment 2: Removal of Residual Hydrogen Sulfide in Salt-Making Distilled Water

The sulfide contents of the distilled water of the first to fifth effects in embodiment 1 are measured to be 0.01 ppm, 0.02 ppm, 0.04 ppm, 0.05 ppm and 0.05 ppm, respectively, according to the method for measuring sulfide content in national standard GB 8538-2016 Methods for Examination of Drinking Natural Mineral Water. After the distilled water is aerated for 10 minutes at room temperature (about 25° C.) with air ventilation amount of 1 vvm, then the sulfide is determined by adopting the same method, and the results show that the sulfide content of the distilled water from the first effect to the fifth effect is less than 0.01 ppm and meets the national standard requirement of the sulfide content in drinking water

### Embodiment 3: Influence of Sand Filtration on the Ion Content

A water sample containing 100 ppm of sodium ions, 20 ppm of calcium ions and 1 ppm of strontium ions is passed through the coarse sand filtration column and the fine sand filtration column continuously at room temperature (about 25° C.) with the flow rates controlled so that the retention time of the water sample in each column is 5 minutes, and the ion contents are measured by ICP to be 110 ppm of sodium ions, 25 ppm of calcium ions and 1.1 ppm of strontium ions, respectively. It can be seen that the sand filtration treatment does not result in a reduction of the ion content.

### Embodiment 4: Effect of Ion Exchange Treatment on Ion Content

The water sample after going through sand filtration in embodiment 3 is further treated with acidic ion exchange resin at room temperature (about 25° C.), for a 2 minute retention time, and the ion concentrations in the treated sample are: 120 ppm of sodium ions, 1.2 ppm of calcium ions and 0.02 ppm of strontium ions. Therefore, the ion exchange can significantly reduce the concentration of divalent ions (such as calcium ions and strontium ions) and can also be used as a method for adjusting the ion content in water sample.

### Embodiment 5: Activated Carbon Adsorption Treatment

The water sample after said active ion exchange treatment in embodiment is further subjected to activated carbon adsorption treatment comprising two-stage treatment, namely granular activated carbon and powdered activated carbon, the flow rate and the height of the activated carbon column are controlled so that the retention time of the water sample in each column is 10 minutes. The ion concentrations of the treated samples are 110 ppm of sodium ion, 1.4 ppm of calcium ion and 0.03 ppm of strontium ion, respectively. It can be seen that the activated carbon adsorption treatment does not cause significant changes in ion content.

### Embodiment 6: Analysis of Reverse Osmosis Membrane Filtration Treatment Conditions

A water sample with a sodium ion content of 100 ppm is treated with AG1812 reverse osmosis membrane manufactured by American General-purpose Company, and the sodium ion content in the permeated water and in the residual water and the rejection rate of sodium ions under different operating pressures are shown in Table 2. It can be seen that reverse osmosis membranes have a high rejection rate for sodium ions.

TABLE 2
Separation result of strontium ions with initial
concentration of 100 ppm by reverse osmosis
membrane of American General-purpose Company

| Operating | C-raw | C-residual | C-permeated | r(rejection |
|---|---|---|---|---|
| pressure/MPa | water/ppm | water/ppm | water/ppm | rate)/% |
| 0.125 | 96.34 | 96.93 | 2.22 | 97.69 |
| 0.25 | 97.18 | 97.94 | 1.87 | 98.08 |
| 0.5 | 97.10 | 98.53 | 1.58 | 98.37 |

The same reverse osmosis membrane is used to treat the water sample containing 10 ppm strontium ions, and the residual water, the strontium ion content in the permeated water, and the strontium ion rejection rate under different operating pressures are shown in Table 3. It can be known that reverse osmosis membranes also have a higher rejection rate for strontium ions.

TABLE 3
Separation result of strontium ions with initial
concentration of 10 ppm by reverse osmosis membrane
of American General-purpose Company

| Operating | C-raw | C-residual | C-permeated | r(rejection |
|---|---|---|---|---|
| pressure/MPa | water/ppm | water/ppm | water/ppm | rate)/% |
| 0.125 | 7.45 | 7.52 | 0.37 | 94.98 |
| 0.25 | 7.48 | 7.68 | 0.37 | 95.12 |
| 0.5 | 7.52 | 7.70 | 0.35 | 95.32 |

The results show that the reverse osmosis membrane has higher rejection rate for sodium ions and strontium ions, and therefore, the reverse osmosis membrane can be used as an effective method for enriching the strontium ions.

### Embodiment 7: Analysis of Conditions of Nano Membrane Filtration Treatment

A separation experiment of sodium ions or strontium ions is carried out by adopting a domestic nanofiltration membrane DK 1812. The water sample is treated at an operating pressure of 0.125 MPa, and the results are shown in Tables 4 and Table 5. It is known that nano membrane filtration has certain selectivity for sodium ion and strontium ion separation and can be used for selectively enriching strontium ions.

TABLE 4
Separation effect of domestic DK1812 nanofiltration membranes
on sodium ions at 0.125 MPa operating pressure

| | C-raw | C-residual | C-permeated | r(rejection |
|---|---|---|---|---|
| C(Na⁺)/ppm | water/ppm | water/ppm | water/ppm | rate)/% |
| 10 | 11.25 | 11.64 | 5.21 | 53.71 |
| 50 | 45.38 | 46.24 | 23.68 | 47.83 |
| 100 | 89.67 | 90.09 | 54.21 | 39.55 |

TABLE 5
Separation effect of domestic DK1812 nanofiltration
membranes on strontium ions at 0.125 MPa

| | C-raw | C-residual | C-permeated | r(rejection |
|---|---|---|---|---|
| C(Sr²⁺)/ppm | water/ppm | water/ppm | water/ppm | rate)/% |
| 10 | 9.02 | 9.13 | 5.81 | 35.63 |
| 50 | 41.74 | 42.31 | 31.61 | 24.27 |
| 100 | 79.53 | 80.13 | 61.83 | 22.26 |

### Embodiment 8: Analysis of Whole Process for Preparing Strontium-Rich Drinking Water from Salt-Making Distilled Water

The fifth-effect condensate water from SICHUAN ZIGONG CHI YU SALT PRODUCT CO., LTD is employed as raw material water, and the contents of sodium ions, calcium ions and strontium ions thereof are respectively measured to be 46.7 ppm, 7.9 ppm and 0.35 ppm; the sulfide content is 0.03 ppm. Subjecting the raw water to aeration treatment at room temperature (about 25° C.) for 5 minutes with air ventilation amount of 1 vvm, and measuring that the sulfide content is less than 0.01 ppm; performing coarse sand filtration and fine sand filtration on the water sample after aeration treatment wherein the retention time is 2 minutes respectively, then performing adsorption treatment by adopting primary activated carbon and secondary activated carbon wherein the retention time is 10 minutes respectively, then performing strontium ion enrichment by adopting an AG1812 reverse osmosis membrane produced by American General-purpose Company, and selecting a concentration ratio of 10:7 to obtain sodium ions, calcium ions and strontium ions in the residual water wherein the contents of the sodium ions, the calcium ions and the strontium ions are 51.8 ppm, 11.6 ppm and 0.39 ppm respectively; the residual water is further subjected to nanofiltration separation treatment, and the contents of sodium ions, calcium ions and strontium ions in the obtained strontium-rich water are shown in the following table when the concentration ratios were 7:6, 7:5 and 7:4, respectively:

TABLE 6
Ion concentration variation in salt-making distilled
water after ion enrichment by reverse osmosis membrane
filtration and further nanofiltration treatment

| | Ca²⁺/ppm | Sr²⁺/ppm | Na²⁺/ppm |
|---|---|---|---|
| Nanofiltration feeding water | 11.47 | 0.39 | 69.29 |
| Concentration ratio of 7:6 | 12.71 | 0.43 | 60.6 |
| Concentration ratio of 7:5 | 13.7 | 0.46 | 78.23 |
| Concentration ratio of 7:4 | 16.17 | 0.51 | 68.44 |
| Residual mixing water | 15.45 | 0.52 | 69.32 |

Sterilizing and disinfecting the water sample after nanofiltration for 10 minutes by adopting 2 g/L ozone, and detecting microorganisms, wherein both of the colony count and the total Escherichia coli count meet the national drinking mineral water standard.

The results show that the method provided by the invention can prepare the salt-making distilled water into the drinking strontium-rich mineral water meeting the national standard, and can realize effective regulation of the ion content.

In the description herein, references terms of “one embodiment,” “some embodiments,” “an example,” “a specific example,” or “some examples,” etc., mean that a particular feature, structure, material, or characteristic described in connection with the embodiment or example is included in at least one embodiment or example of the invention. In this specification, the schematic representations of the terms used above are not necessarily intended to refer to the same embodiment or example. Furthermore, the particular features, structures, materials, or characteristics described may be combined in any suitable manner in any one or more embodiments or examples. Furthermore, various embodiments or examples and features of different embodiments or examples described in this specification can be combined and combined by one skilled in the art without contradiction.

The invention and its embodiments have been described above, but the description is not limited thereto; only one embodiment of the invention is shown in the drawings, and the actual structure is not limited thereto. In general, it is to be understood by those skilled in the art that non-creative design of structural forms and embodiments that are similar to the technical solutions without departing from the spirit of the invention shall all fall within the protective scope of the invention.

1. A drinking strontium-rich mineral water containing 2-100 mg/L of sodium ions, 0.4-1.5 mg/L of strontium ions, and 0.5-20 mg/L of calcium ions.

2. A method for preparing drinking strontium-rich mineral water comprising following steps:
(1) carrying out aeration pretreatment on the salt-making distilled water to obtain pretreated distilled water;
(2) performing sand filtration treatment on said pretreated distilled water to obtain first treated water;
(3) conducting ion exchange treatment on said first treated water to obtain second treated water;
(4) performing activated carbon adsorption treatment on said second treated water to obtain third treated water;
(5) performing membrane filtration treatment on said third treated water to obtain fourth treated water;
(6) sterilizing and disinfecting the fourth treated water to obtain the drinking strontium-inch mineral water.

3. The method of claim 2 wherein said operating conditions of the aeration pretreatment comprise: the air ventilation amount is 0.1-10 vvm, the temperature is 20-60° C., and the retention time is 1-60 minutes.

4. The method of claim 2 wherein said conditions of the sand filtration process include: the temperature is 20-60° C., and the retention time is 1-30 minutes.

5. The method of claim 2 wherein said ion exchange treatment is cation exchange, and the treatment conditions include: the temperature is 20-50° C., and the retention time is 1-60 minutes.

6. The method of claim 2 wherein the conditions of said activated carbon adsorption treatment include: the temperature is 20-40° C., and the retention time is 10-60 minutes.

7. The method of claim 2 wherein the conditions of the membrane filtration process include: the temperature is 20-40° C., the operation pressure is 0.15-5 MPa, and the concentration ratio is 10:(9-2).

8. The method of claim 2 wherein the conditions of said sterilization and disinfection process include: the temperature is 20-40′C, the ozone dosage is 1-10 tg/L water, and the retention time is 1-30 minutes.

9. A system for implementing method of claim 1 comprising the aeration unit, the sand filtration unit, the ion exchange unit, the activated carbon adsorption treatment unit, the membrane filtration unit and the sterilization and disinfection unit connected in sequence;
optionally, said sand filtration unit includes coarse sand filtration apparatus and fine sand filtration apparatus;
optionally, said activated carbon adsorption treatment unit includes a primary activated carbon adsorption treatment device and a secondary activated carbon adsorption treatment device;
optionally, said membrane filtration unit includes a reverse osmosis apparatus and/or a nanofiltration apparatus.

10. The drinking strontium-rich mineral water wherein said drinking strontium-rich mineral water is prepared by the method of claim 2.
